(19) United States
(12) Patent Application Publication
(10) Pub. No.: US 2007/0216621 A1
(43) Pub. Date: Sep. 20, 2007

(54) Optically compensated bend (OCB) liquid crystal display

(75) Inventors: Yi-Chang Lai, Miao-Li (TW); Chien-Jen Chang, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/725,721

(22) Filed: Mar. 19, 2007

(30) Foreign Application Priority Data
Mar. 17, 2006 (TW) 95109298

(51) Int. Cl. G09G 3/36

(52) U.S. Cl. 345/87

(57) ABSTRACT

An exemplary optically compensated bend liquid crystal display (OCB-mode LCD) (20) has a liquid crystal panel (30), which has a pixel electrode (31) and a common electrode (32); a common voltage supply unit (24) providing a common voltage signal to the common electrode; a gamma circuit (26) providing a data voltage signal to the pixel electrode; a gate driving circuit (22), which has a high-voltage supply circuit (223) providing a high voltage, higher than a max voltage signal of the gamma circuit; and a data signal switching unit (29) connecting with the gamma circuit, the high-voltage supply circuit and the liquid crystal panel. The data signal switching unit can selectively output the voltage signal from the gamma circuit or the high-voltage supply circuit.

### FIELD OF THE INVENTION

The present invention relates to a liquid crystal display, and more particularly to an optically compensated bend liquid crystal display (OCB-mode LCD).

### GENERAL BACKGROUND

With the widespread use of liquid crystal display devices, such as in high-end portable electronic devices, mobile phones, and PDAs (Personal Digital Assistants), the demand for greater picture quality is ever present.

Conventional liquid crystal display devices employ, as one example of liquid crystal display modes, twisted nematic (TN) mode liquid crystal display elements using a nematic liquid crystal with positive dielectric anisotropy, but these have the shortcomings of a slow response and narrow viewing angles. There are also display modes with slow response and broad viewing angles, using a ferroelectric liquid crystal (FLC) or anti-ferroelectric liquid crystal, but these have shortcomings with regard to burn-in, shock resistance, and temperature dependence. There is also the in-plane switching (IPS) mode which has extremely broad viewing angles, in which the liquid crystal molecules are driven within the display plane by a transversal electric field, but the response times are slow, and numerical aperture and luminance are low. When trying to display full-color moving images on large screens, a liquid crystal mode with broad viewing angle, high luminance and fast display properties is necessary, but at present, a liquid crystal display mode that perfectly satisfies all these requirements in practice does not exist.

Among the conventional liquid crystal display devices that aimed for at least a broad viewing angle and high luminance are liquid crystal display devices in which TN mode liquid crystal regions are partitioned into two domains to widen the viewing angle vertically (see SID 92 DIGEST p. 798-801). That is to say, using a nematic liquid crystal with positive dielectric anisotropy in the display pixels of the liquid crystal display device, two TN mode liquid crystal regions with different alignment orientation of the liquid crystal molecules are formed, and the viewing angle is enlarged by this TN-mode with two alignment domains.

As for liquid crystal display modes utilizing the so-called homeotropic alignment mode, in which the liquid crystal molecules are aligned approximately vertically at the boundaries to the alignment films, there are liquid crystal display devices with broad viewing angle and fast response that are provided with film phase-difference plates and subjected to alignment partitioning, but again the response time between black and white display is about 25 ms, and in particular the response time for gray scales is slow at 50-80 ms, which is longer than the 1/30 s that are held to be the visual speed of the human eye, so that moving images appear blurred.

On the other hand, a bend alignment type liquid crystal display device (OCB-mode liquid crystal display device) has been proposed, which utilizes changes of the refractive index due to changes in the angle with which the liquid crystal molecules rise when the liquid crystal molecules between the substrates are in bend alignment. The speed with which the orientation of bend aligned liquid crystal molecules changes in the ON state and the OFF state is much faster than the speed of orientation changes between ON and OFF states in TN liquid crystal display devices, so that a liquid crystal display device with fast response time can be obtained. Moreover, in this bend alignment type liquid crystal display device, optical phase differences can be compensated automatically, because all the liquid crystal molecules are bend aligned between the upper and lower substrates, and the liquid crystal display device has potential as a liquid crystal display device with low voltage and broad viewing angle, because phase differences are compensated by the film phase difference plates.

Incidentally, these liquid crystal display devices are manufactured such that the liquid crystal molecules between the substrates are in splay alignment when no voltage is applied. In order to change the refractive index using bend alignment, the entire display portion has to be transitioned uniformly from splay alignment to bend alignment before use of the liquid crystal display device. When applying a voltage between the opposing display electrodes, the transition seeds for the transition from splay alignment to bend alignment do not appear in uniform distribution, but around the distributed spacers, at alignment irregularities at the boundary to the alignment films, or at damaged portions. Furthermore, the transition seeds do not necessarily appear always at the same locations, which may easily lead to display defects, in which the transition sometimes takes place and sometimes does not take place. Consequently, it is very important that at least all pixel portions of the entire display portion are transitioned uniformly from splay alignment to bend alignment before use.

However, conventionally, when applying a simple ac voltage, the transition sometimes does not take place, and when it does take place, the transition time is very long.

What is needed, therefore, is a prism sheet and a prism sheet module that can overcome the above-described deficiencies.

### SUMMARY

An exemplary optically compensated bend liquid crystal display (OCB-mode LCD) has a liquid crystal panel, which has a pixel electrode and a common electrode; a common voltage supply unit providing a common voltage signal to the common electrode; a gamma circuit providing a data voltage signal to the pixel electrode; a gate driving circuit, which has a high-voltage supply circuit providing a high voltage, higher than a max voltage signal of the gamma circuit; and a data signal switching unit connecting with the gamma circuit, the high-voltage supply circuit and the liquid crystal panel. The data signal switching unit can selectively output the voltage signal from the gamma circuit or the high-voltage supply circuit.

Another exemplary optically compensated bend liquid crystal display (OCB-mode LCD) has a liquid crystal panel, which has a pixel electrode and a common electrode; a common voltage supply unit providing a common voltage signal to the common electrode; a gamma circuit providing a data voltage signal to the pixel electrode; a gate driving circuit, which has a high-voltage supply circuit providing a high voltage, higher than a max voltage signal of the gamma circuit, and a low-voltage supply circuit providing a high voltage, lower than a common voltage signal of the common voltage supply unit; a data signal switching unit connecting with the gamma circuit, the high-voltage supply circuit and the liquid crystal panel; and a common signal switching unit connecting with the low-voltage supply circuit, the common voltage supply unit and the liquid crystal panel. The data signal switching unit can selectively output the voltage signal from the gamma circuit or the high-voltage supply circuit, and the common signal switching unit can selectively output the voltage signal from the low-voltage supply circuit or the common voltage supply unit.

### BRIEF DESCRIPTION OF THE DRAWINGS

FIG. 1 is a block circuit diagram showing a configuration a liquid crystal display according to a first embodiment of the present invention.

FIG. 2 is a block circuit diagram showing a configuration a liquid crystal display according to a second embodiment of the present invention.

FIG. 3 is a block circuit diagram showing a configuration a liquid crystal display according to a third embodiment of the present invention.

### DETAILED DESCRIPTION OF PREFERRED EMBODIMENTS

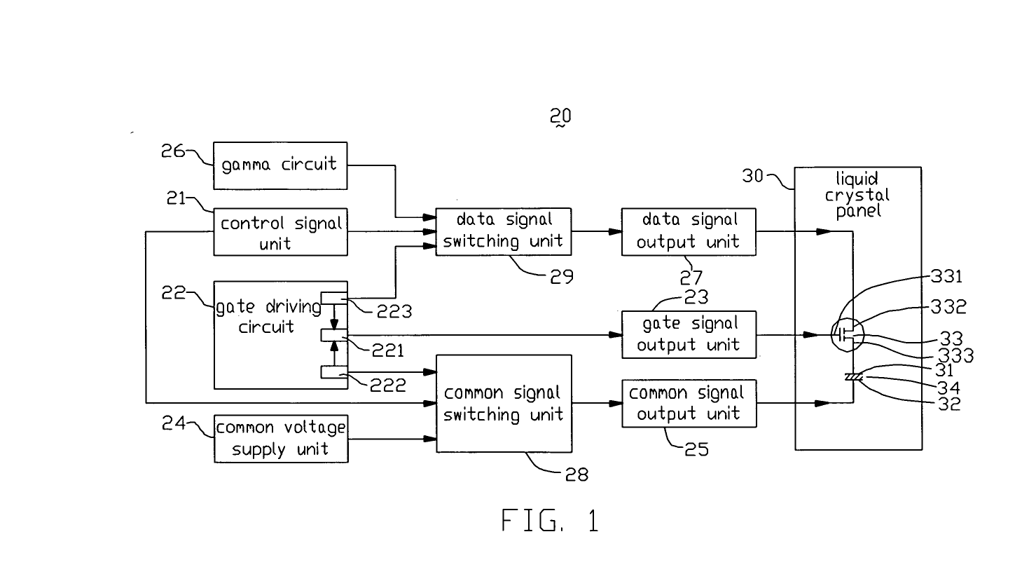

FIG. 1 shows optically compensated bend liquid crystal display (OCB-mode LCD) 20 according to a first embodiment of the present invention. The LCD 20 has a control signal unit 21, a gate driving circuit 22, a gate signal output unit 23, a common voltage supply unit 24, a common signal output unit 25, a gamma circuit 26, a data signal output unit 27, a common signal switching unit 28, a data signal switching unit 29, and a liquid crystal panel 30. The gamma circuit 26, the data signal switching unit 29, and the data signal output unit 27 connect in series, the data signal output unit 27 connecting to the liquid crystal panel 30. The common voltage supply unit 24, the common signal switching unit 28, and the common signal output unit 25 connect in series, the common signal output unit 25 connecting to the liquid crystal panel 30. The gate signal output unit 23 connects to the liquid crystal panel 30.

The gate driving circuit 22 has a gate signal supply circuit 221, a low-voltage supply circuit 222, a high-voltage supply circuit 223. The gate signal supply circuit 221 supplies a gate driving signal, which is a pulsing signal. The pulsing signal has a high potential, higher than a max potential provided by the gamma circuit 26, and a low potential, lower than a potential provided by the common voltage supply unit 24. The high potential and the low potential are respectively provided by the high-voltage supply circuit 223 and the low-voltage supply circuit 222. The low-voltage supply circuit 222 connects to the common signal switching unit 28; and the high-voltage supply circuit 223 connects to the data signal switching unit 29. The gate signal supply circuit 221 connects to the liquid crystal panel 30 through the gate signal output unit 23, for providing a gate driving signal to the liquid crystal panel 30.

One pixel of the liquid crystal panel 30 has a pixel electrodes 31, a common electrode 32, a TFT 33, and a liquid crystal layer (not shown) between the pixel electrode 31 and the common electrode 32. The TFT 33 has a gate electrode 331 connecting to the gate signal output unit 23, a source electrode 332 connecting to the data signal output unit 27, and a drain electrode 333 connecting to the pixel electrode 31. The common electrode 32 connects to the common signal output unit 25.

When the LCD 20 are initialized, the control signal unit 21 sends a control signal to the common signal switching unit 28 and the data signal switching unit 29 for controlling the common signal switching unit 28 selectively outputting the low-voltage signal from the low-voltage supply circuit 222 to the common signal output unit 25, and controlling the data signal switching unit 29 selectively outputting the high-voltage signal from the high-voltage supply circuit 223 to the data signal output unit 27. The gate signal supply circuit 221 of the gate driving circuit 22 outputs a gate driving signal to the gate electrode 331 of the TFT 33, through the gate signal output unit 23, and turns on the TFT 33. When the TFT 33 turns on, the pixel electrode 31 has a potential same to the high-voltage signal from the high-voltage supply circuit 223, and the common electrode 32 has a potential same to the low-voltage signal from the low-voltage supply circuit 222. Thus, an electrical field is formed, which drives the liquid crystal molecules transition from splay alignment to bend alignment.

When the LCD 20 displays an image, the control signal unit 21 sends a control signal to the common signal switching unit 28 and the data signal switching unit 29 for controlling the common signal switching unit 28 selectively outputting the voltage signal from the common voltage signal from the common voltage supply unit 24 to the common signal output unit 25, and controlling the data signal switching unit 29 selectively outputting the voltage signal from the gamma circuit 26 to the data signal output unit 27. The gate signal supply circuit 221 of the gate driving circuit 22 outputs a gate driving signal to the gate electrode 331 of the TFT 33, through the gate signal output unit 23, and turns on the TFT 33. When the TFT 33 turns on, the pixel electrode 31 has a potential same to the voltage signal from the gamma circuit 26, and the common electrode 32 has a potential same to the voltage signal from the common voltage supply circuit 24. Thus, the LCD 20 displays images.

Comparing to the conventional technology, because the gate signal supply circuit 221 supplies a gate driving signal, which has a high potential provided by the high-voltage supply circuit 223, higher than a max potential provided by the gamma circuit 26, and a low potential provided by the low-voltage supply circuit 222, lower than a potential provided by the common voltage supply unit 24. Thus, in the process of initializing, a voltage difference between the pixel electrode 31 and the common electrode 32 is higher. So, the initializing time is shortened.

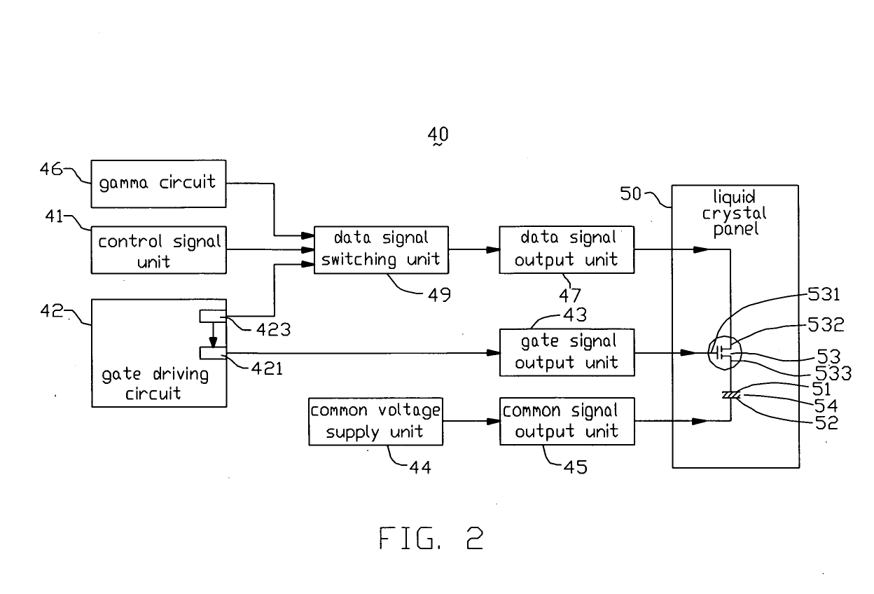

FIG. 2 shows optically compensated bend liquid crystal display (OCB-mode LCD) 40 according to a second embodiment of the present invention. The LCD 40 has a control signal unit 41, a gate driving circuit 42, a gate signal output unit 43, a common voltage supply unit 44, a common signal output unit 45, a gamma circuit 46, a data signal output unit 47, a data signal switching unit 49, and a liquid crystal panel 50. The gamma circuit 46, the data signal switching unit 49, and the data signal output unit 47 connect in series, the data signal output unit 47 connecting to the liquid crystal panel 50. The common voltage supply unit 44, and the common signal output unit 55 connect in series, the common signal output unit 45 connecting to the liquid crystal panel 50. The gate signal output unit 43 connects to the liquid crystal panel 50.

The gate driving circuit 42 has a gate signal supply circuit 421, and a high-voltage supply circuit 423. The gate signal supply circuit 421 supplies a gate driving signal, which is a pulsing signal. The pulsing signal has a high potential provided by the high-voltage supply circuit 223, higher than a max potential provided by the gamma circuit 46. The high-voltage supply circuit 423 connects to the data signal switching unit 49. The gate signal supply circuit 421 connects to the liquid crystal panel 50 through the gate signal output unit 43, for providing a gate driving signal to the liquid crystal panel 50.

One pixel of the liquid crystal panel 50 has a pixel electrodes 51, a common electrode 52, a TFT 53, and a liquid crystal layer (not shown) between the pixel electrode 51 and the common electrode 52. The TFT 53 has a gate electrode 531 connecting to the gate signal output unit 43, a source electrode 532 connecting to the data signal output unit 47, and a drain electrode 533 connecting to the pixel electrode 51. The common electrode 52 connects to the common signal output unit 45.

Comparing to the conventional technology, because the gate signal supply circuit 421 supplies a gate driving signal, which has a high potential provided by the high-voltage supply circuit 423, higher than a max potential provided by the gamma circuit 46. Thus, in the process of initializing, a voltage difference between the pixel electrode 51 and the common electrode 52 is higher. So, the initializing time is shortened.

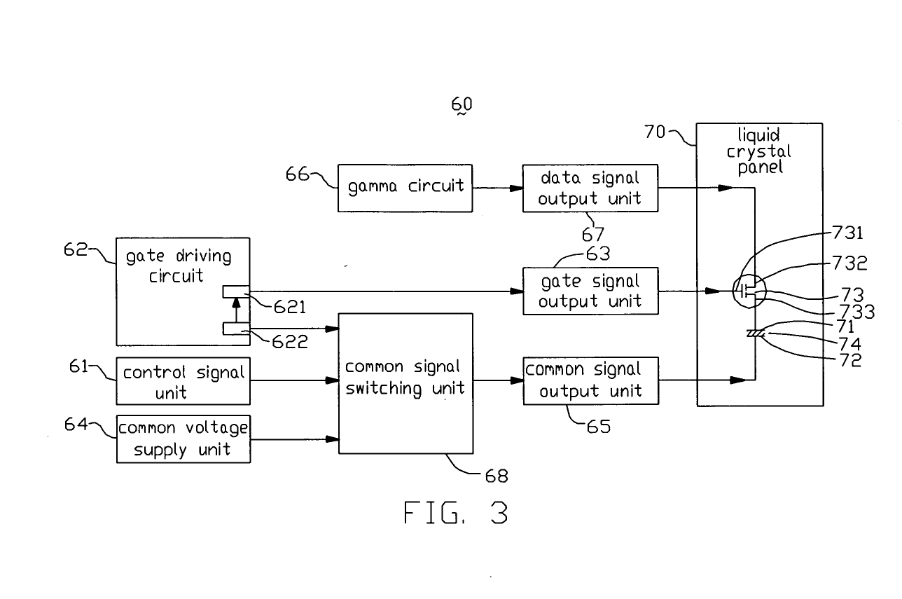

FIG. 3 shows optically compensated bend liquid crystal display (OCB-mode LCD) 60 according to a first embodiment of the present invention. The LCD 60 has a control signal unit 61, a gate driving circuit 62, a gate signal output unit 63, a common voltage supply unit 64, a common signal output unit 65, a gamma circuit 66, a data signal output unit 67, a common signal switching unit 28, and a liquid crystal panel 70. The gamma circuit 66, and the data signal output unit 67 connect in series, the data signal output unit 67 connecting to the liquid crystal panel 70. The common voltage supply unit 64, the common signal switching unit 68, and the common signal output unit 65 connect in series, the common signal output unit 65 connecting to the liquid crystal panel 70. The gate signal output unit 63 connects to the liquid crystal panel 70.

The gate driving circuit 62 has a gate signal supply circuit 621, a low-voltage supply circuit 622. The gate signal supply circuit 621 supplies a gate driving signal, which is a pulsing signal. The pulsing signal has a low potential provided by the low-voltage supply circuit 222, lower than a potential provided by the common voltage supply unit 24. The low-voltage supply circuit 622 connects to the common signal switching unit 68. The gate signal supply circuit 621 connects to the liquid crystal panel 70 through the gate signal output unit 63, for providing a gate driving signal to the liquid crystal panel 70.

One pixel of the liquid crystal panel 70 has a pixel electrodes 71, a common electrode 72, a TFT 73, and a liquid crystal layer (not shown) between the pixel electrode 71 and the common electrode 72. The TFT 73 has a gate electrode 731 connecting to the gate signal output unit 63, a source electrode 732 connecting to the data signal output unit 27, and a drain electrode 333 connecting to the pixel electrode 71. The common electrode 72 connects to the common signal output unit 65.

Comparing to the conventional technology, because the gate signal supply circuit 621 supplies a gate driving signal, which has a low potential provided by the low-voltage supply circuit 622, lower than a potential provided by the common voltage supply unit 64. Thus, in the process of initializing, a voltage difference between the pixel electrode 31 and the common electrode 32 is higher. So, the initializing time is shortened.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optically compensated bend liquid crystal display (OCB-mode LCD), comprising:
a liquid crystal panel, which has a pixel electrode and a common electrode;
a common voltage supply unit providing a common voltage signal to the common electrode;
a gamma circuit providing a data voltage signal to the pixel electrode;
a gate driving circuit, which comprises a high-voltage supply circuit providing a high voltage, higher than a max voltage signal of the gamma circuit; and
a data signal switching unit connecting with the gamma circuit, the high-voltage supply circuit and the liquid crystal panel;
wherein the data signal switching unit can selectively output the voltage signal from the gamma circuit or the high-voltage supply circuit.

2. The OCB-mode LCD as claimed in claim 1, further comprising a control signal unit connecting with the data signal switching unit, for controlling the output of the data signal switching unit.

3. The OCB-mode LCD as claimed in claim 2, further comprising a gate signal output unit connecting with a gate signal supply circuit of the gate driving circuit and the liquid crystal panel.

4. The OCB-mode LCD as claimed in claim 3, further comprising a data signal output unit respectively connecting with the data signal switching unit and the liquid crystal panel, sending signals from the data signal switching unit to the liquid crystal panel.

5. The OCB-mode LCD as claimed in claim 4, wherein the liquid crystal panel further comprises a TFT, which has a gate electrode connecting to the gate signal output unit, a source electrode connecting to the data signal output unit, and a drain electrode connecting to the pixel electrode.

6. An optically compensated bend liquid crystal display (OCB-mode LCD), comprising:
a liquid crystal panel, which has a pixel electrode and a common electrode;
a common voltage supply unit providing a common voltage signal to the common electrode;
a gamma circuit providing a data voltage signal to the pixel electrode;
a gate driving circuit, which comprises a high-voltage supply circuit providing a high voltage, higher than a max voltage signal of the gamma circuit, and a low-voltage supply circuit providing a high voltage, lower than a common voltage signal of the common voltage supply unit;
a data signal switching unit connecting with the gamma circuit, the high-voltage supply circuit and the liquid crystal panel; and
a common signal switching unit connecting with the low-voltage supply circuit, the common voltage supply unit and the liquid crystal panel;
wherein the data signal switching unit can selectively output the voltage signal from the gamma circuit or the high-voltage supply circuit, and the common signal switching unit can selectively output the voltage signal from the low-voltage supply circuit or the common voltage supply unit.

7. The OCB-mode LCD as claimed in claim 6, further comprising a control signal unit connecting with the data signal switching unit and the common signal switching unit, for controlling the output of the data signal switching unit and the common signal switching unit.

8. The OCB-mode LCD as claimed in claim 7, further comprising a gate signal output unit connecting with a gate signal supply circuit of the gate driving circuit and the liquid crystal panel.

9. The OCB-mode LCD as claimed in claim 8, further comprising a common signal output unit connecting with a common signal supply circuit and the liquid crystal panel.

10. The OCB-mode LCD as claimed in claim 9, further comprising a data signal output unit respectively connecting with the data signal switching unit and the liquid crystal panel, sending signals from the data signal switching unit to the liquid crystal panel.

11. The OCB-mode LCD as claimed in claim 10, wherein the liquid crystal panel further comprises a TFT, which has a gate electrode connecting to the gate signal output unit, a source electrode connecting to the data signal output unit, and a drain electrode connecting to the pixel electrode.

12. An optically compensated bend liquid crystal display (OCB-mode LCD), comprising:
a liquid crystal panel, which has a pixel electrode and a common electrode;
at least one of a data signal switching unit and a common signal switching unit;
a gamma circuit and a common voltage supply unit arranged in a condition of at least either the gamma circuit being connected to the data signal switching unit or the common voltage supply unit being connected to the common signal switching unit;
a gate driving circuit being connected to one of said data signal switching unit and said common signal switching unit when only said one of said data signal switching unit and said common signal switching unit is available, or to both of said data signal switching unit and said common signal switching unit if said both of said data signal switching unit and said common signal switching unit are available; and
a control signal unit being connected to one of said data signal switching unit and said common signal switching unit when only said one of said data signal switching unit and said common signal switching unit is available, or to both of said data signal switching unit and said common signal switching unit if said both of said data signal switching unit and said common signal switching unit are available.
